(19) United States
(12) Patent Application Publication
(10) Pub. No.: US 2019/0180710 A1
(43) Pub. Date: Jun. 13, 2019

(54) DISPLAY APPARATUS AND METHOD OF DRIVING DISPLAY PANEL USING THE SAME

(71) Applicant: Samsung Display Co., Ltd., Yongin-Si (KR)

(72) Inventor: Wontae KIM, Hwaseong-si (KR)

(21) Appl. No.: 16/184,214

(22) Filed: Nov. 8, 2018

(30) Foreign Application Priority Data
Dec. 11, 2017 (KR) 10-2017-0169716

(51) Int. Cl. G09G 3/36

(52) U.S. Cl. CPC G09G 3/3696; G09G 3/3674; G09G 3/3685; G09G 2310/0243; G09G 2310/0291; G09G 2310/08; G09G 2310/0297; G09G 3/3614

(57) ABSTRACT

A display apparatus includes a display panel, a gate driver and a data driver. The display panel includes a plurality of display blocks. The gate driver generates a plurality of gate signals and outputs the plurality of the gate signals to a plurality of gate lines. The data driver generates a plurality of data voltages, outputs the plurality of the data voltages to a plurality of data lines, generates common voltages and outputs the common voltages to the display panel. The data driver includes a plurality of driving blocks. The driving blocks generate the common voltages and output the common voltages to the display blocks.

This application claims priority to Korean Patent Application No. 10-2017-0169716, filed on Dec. 11, 2017, and all the benefits accruing therefrom under 35 U.S.C. § 119, the content of which in its entirety is herein incorporated by reference.

### BACKGROUND

### 1. Field

Exemplary embodiments of the inventive concept relate to a display apparatus and a method of driving a display panel using the display apparatus. More particularly, exemplary embodiments of the inventive concept relate to a display apparatus including a data driver including driving blocks which generate common voltages and output the common voltages to display blocks of the display panel to enhance a uniformity of the common voltages and a method of driving a display panel using the display apparatus.

### 2. Description of the Related Art

A display apparatus includes a display panel and a display panel driver. The display panel driver generally includes a timing controller, a gate driver and a data driver. The timing controller adjusts driving timings of the gate driver and the data driver. The gate driver outputs gate signals to gate lines. The data driver outputs data voltages to data lines.

The display panel driver may further include a common voltage generator. The common voltage generator generates a common voltage and outputs the common voltage generator to the display panel.

Pixels of the display panel display desired grayscales using a difference of the data voltage and the common voltage.

### SUMMARY

As a size of the display panel increases, the common voltage may vary according to a position in the display panel such that the display quality of the display panel may be deteriorated.

In addition, when the display panel displays a specific pattern in a specific polarity inversion driving method, the pixels of the display panel may not display the desired grayscales due to an oscillation of the common voltage such that the display quality of the display panel may be deteriorated.

Exemplary embodiments of the inventive concept provide a display apparatus including a data driver including driving blocks which generate common voltages and output the common voltages to display blocks of the display panel.

Exemplary embodiments of the inventive concept also provide a method of driving a display panel using the above-mentioned display apparatus.

In an exemplary embodiment according to the inventive concept, a display apparatus includes a display panel, a gate driver and a data driver. The display panel includes a plurality of display blocks. The gate driver generates a plurality of gate signals and outputs the plurality of the gate signals to a plurality of gate lines. The data driver generates a plurality of data voltages, outputs the plurality of the data voltages to a plurality of data lines, generates common voltages and outputs the common voltages to the display panel. The data driver includes a plurality of driving blocks. The driving blocks generate the common voltages and output the common voltages to the display blocks.

In an exemplary embodiment, the display blocks may extend along an extending direction of the data lines. The display blocks may be arranged along an extending direction of the gate lines.

In an exemplary embodiment, the driving blocks may be respectively integrated circuits connected to an end portion of the display panel.

In an exemplary embodiment, the driving block may include a plurality of data voltage amplifiers which output the data voltages to the data lines and at least one common voltage amplifier which outputs the common voltage to the display panel.

In an exemplary embodiment, the driving block may further include a decoder which receives a common voltage base signal from a timing controller and generates the common voltage based on the common voltage base signal.

In an exemplary embodiment, the driving block may further include a feedback part which compares a fed-back common voltage from the display panel with a reference voltage and generates a comparing signal and a polarity converting part which converts a polarity inversion driving method of the display panel based on the comparing signal.

In an exemplary embodiment, the feedback part may include a first comparator comprising a first input terminal receiving the fed-back common voltage, a second input terminal receiving a first reference voltage which is greater than a target common voltage and an output terminal outputting a first comparing signal when the fed-back common voltage is greater than the first reference voltage and a second comparator comprising a first input terminal receiving the fed-back common voltage, a second input terminal receiving a second reference voltage which is less than the target common voltage and an output terminal outputting a second comparing signal when the fed-back common voltage is less than the second reference voltage.

In an exemplary embodiment, the feedback part may include a first comparator comprising a first input terminal receiving the fed-back common voltage, a second input terminal receiving a first reference voltage which is greater than a target common voltage and an output terminal outputting a first comparing signal when the fed-back common voltage is greater than the first reference voltage, a second comparator comprising a first input terminal receiving the fed-back common voltage, a second input terminal receiving a second reference voltage which is less than the target common voltage and an output terminal outputting a second comparing signal when the fed-back common voltage is less than the second reference voltage, a third comparator comprising a first input terminal receiving the fed-back common voltage, a second input terminal receiving a third reference voltage which is greater than the first reference voltage and an output terminal outputting a third comparing signal when the fed-back common voltage is greater than the third reference voltage and a fourth comparator comprising a first input terminal receiving the fed-back common voltage, a second input terminal receiving a fourth reference voltage which is less than the second reference voltage and an output terminal outputting a fourth comparing signal when the fed-back common voltage is less than the fourth reference voltage.

In an exemplary embodiment, the driving blocks may further include a multiplexer disposed between the data voltage amplifiers and the data lines and which determines connections between the data voltage amplifiers and the data lines.

In an exemplary embodiment, the polarity inversion driving method may include a first mode and a second mode. The polarity converting part may convert the polarity inversion driving method between the first mode and the second mode according to the comparing signal. Polarities of the data voltages may be inverted every data line in the first mode. The polarities of the data voltages may be inverted every two data lines in the second mode.

In an exemplary embodiment, the polarity inversion driving method may include a first mode and a second mode. The polarity converting part may convert the polarity inversion driving method between the first mode and the second mode according to the comparing signal. Polarities of the data voltages may be inverted every data line in the first mode. The polarities of the data voltages may be inverted every six data lines in the second mode.

In an exemplary embodiment, the polarity inversion driving method may include a first mode and a second mode. The polarity converting part may convert the polarity inversion driving method between the first mode and the second mode according to the comparing signal. Polarities of the data voltages may be inverted every two data lines in the first mode. The polarities of the data voltages may be inverted every six data lines in the second mode.

In an exemplary embodiment, the polarity inversion driving method may include a first mode, a second mode and a third mode. The polarity converting part may convert the polarity inversion driving method among the first mode, the second mode and the third mode according to the comparing signal. Polarities of the data voltages may be inverted every data line in the first mode. The polarities of the data voltages may be inverted every two data lines in the second mode. The polarities of the data voltages may be inverted every six data lines in the third mode.

In an exemplary embodiment, the timing controller may include a feedback part which compares a fed-back common voltage from the display panel with a reference voltage and generates a comparing signal and a polarity converting part which converts a polarity inversion driving method of the display panel based on the comparing signal.

In an exemplary embodiment of a method of driving a display panel according to the inventive concept, the method includes generating a plurality of gate signals, outputting the plurality of the gate signals to a plurality of gate lines, generating a plurality of data voltages, outputting the plurality of the data voltages to a plurality of data lines, generating a plurality of common voltages and outputting the plurality of the common voltages to a plurality of driving blocks of the display panel.

In an exemplary embodiment, the method may further include comparing a fed-back common voltage from the display panel with a reference voltage, generating a comparing signal based on a result of the comparing the fed-back common voltage with the reference voltage and converting a polarity inversion driving method of the display panel based on the comparing signal.

In an exemplary embodiment, generating the comparing signal may include comparing the fed-back common voltage with a first reference voltage greater than a target common voltage, outputting a first comparing signal when the fed-back common voltage is greater than the first reference voltage, comparing the fed-back common voltage with a second reference voltage less than the target common voltage and outputting a second comparing signal when the fed-back common voltage is less than the second reference voltage.

In an exemplary embodiment, generating the comparing signal may further include comparing the fed-back common voltage with a third reference voltage greater than the first reference voltage, outputting a third comparing signal when the fed-back common voltage is greater than the third reference voltage, comparing the fed-back common voltage with a fourth reference voltage less than the second reference voltage and outputting a fourth comparing signal when the fed-back common voltage is less than the fourth reference voltage.

In an exemplary embodiment, converting the polarity inversion driving method of the display panel may include determining connections between a plurality of data voltage amplifiers and the plurality of the data lines using a multiplexer disposed between the plurality of the data voltage amplifiers and the plurality of the data lines.

According to the display apparatus and the method of driving the display panel of the display apparatus, the driving blocks of the data driver generate the common voltages and output the common voltages to the display blocks of the display panel such that the uniformity of the common voltage may be enhanced.

In addition, the polarity inversion driving method of the display panel may be converted using a waveform of the fed-back common voltage when the distortion of the common voltage occurs. Therefore, the distortion of the common voltage may be reduced.

As a result, the level of the common voltage may be stabilized such that the display quality of the display panel may be enhanced.

### BRIEF DESCRIPTION OF THE DRAWINGS

The above and other features and advantages of the inventive concept will become more apparent by describing in detailed exemplary embodiments thereof with reference to the accompanying drawings, in which:

FIG. 1 is a block diagram illustrating an exemplary embodiment of a display apparatus according to the inventive concept;

FIG. 2 is a conceptual diagram illustrating an exemplary embodiment of a pixel structure of a display panel of FIG. 1;

FIG. 3A is a conceptual diagram illustrating an exemplary embodiment of the display panel of FIG. 2 displaying a checker board pattern;

FIG. 3B is a timing diagram illustrating an exemplary embodiment of data voltages and a common voltage when the display panel of FIG. 2 displays the checker board pattern of FIG. 3A;

FIG. 4A is a conceptual diagram illustrating an exemplary embodiment of the display panel of FIG. 2 displaying a sub checker board pattern;

FIG. 4B is a timing diagram illustrating an exemplary embodiment of data voltages and a common voltage when the display panel of FIG. 2 displays the sub checker board pattern of FIG. 4A;

FIG. 5 is a plan view illustrating the display panel and a data driver of FIG. 1;

FIG. 6A is a conceptual diagram illustrating a first driving block of FIG. 5;

FIG. 6B is a conceptual diagram illustrating a second driving block of FIG. 5;

FIG. 7 is a circuit diagram illustrating a common voltage generator of the first driving block of FIG. 6A;

FIG. 8 is a block diagram illustrating a feedback part and a polarity converting part of the data driver of FIG. 5;

FIG. 9 is a circuit diagram illustrating the feedback part of FIG. 8;

FIG. 10 is a timing diagram illustrating a waveform of a fed-back common voltage of FIG. 9;

FIGS. 11A and 11B are conceptual diagrams illustrating a polarity inversion driving method of a first mode;

FIGS. 12A and 12B are conceptual diagrams illustrating a polarity inversion driving method of a second mode;

FIGS. 13A and 13B are conceptual diagrams illustrating a polarity inversion driving method of a third mode;

FIG. 14 is a circuit diagram illustrating an exemplary embodiment of a feedback part of a data driver of a display apparatus according to the inventive concept;

FIG. 15 is a timing diagram illustrating an exemplary embodiment of a waveform of a fed-back common voltage of FIG. 14; and

FIG. 16 is a block diagram illustrating an exemplary embodiment of a feedback part and a polarity converting part of a timing controller of a display apparatus according to the inventive concept.

### DETAILED DESCRIPTION

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Hereinafter, the inventive concept will be explained in detail with reference to the accompanying drawings.

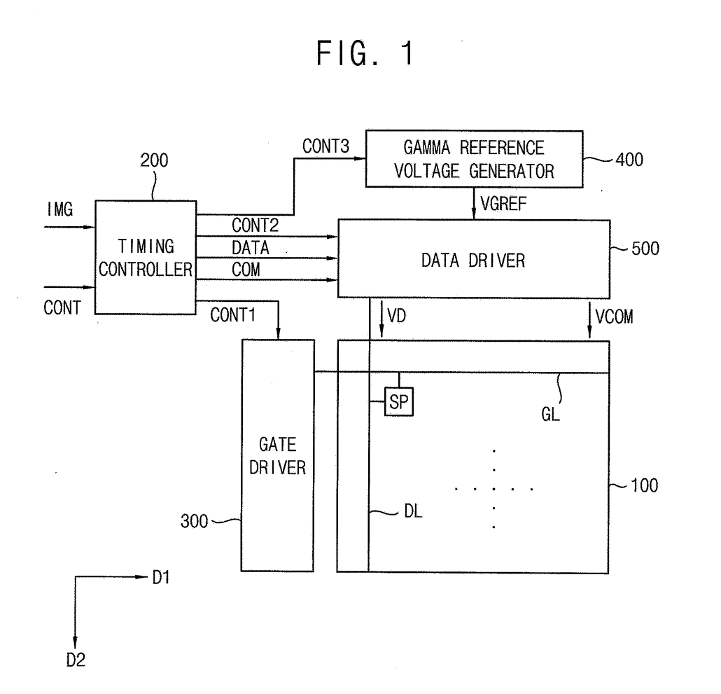

FIG. 1 is a block diagram illustrating an exemplary embodiment of a display apparatus according to the inventive concept.

Referring to FIG. 1, the display apparatus includes a display panel 100 and a display panel driver. The display panel driver includes a timing controller 200, a gate driver 300, a gamma reference voltage generator 400 and a data driver 500.

The display panel 100 includes an active region displaying an image and a peripheral region adjacent to the active region. In an exemplary embodiment, for example, the display panel 100 may be a display panel of a liquid crystal display apparatus which includes a liquid crystal layer.

The display panel 100 includes a plurality of gate lines GL, a plurality of data lines DL and a plurality of subpixels SP electrically connected to the gate lines GL and the data lines DL. The gate lines GL extend in a first direction D1 and the data lines DL extend in a second direction D2 crossing the first direction D1.

The timing controller 200 receives input image data IMG and an input control signal CONT from an external apparatus (not shown). The input image data IMG may include red image data, green image data and blue image data. The input control signal CONT may include a master clock signal and a data enable signal. The input control signal CONT may further include a vertical synchronizing signal and a horizontal synchronizing signal.

The timing controller 200 generates a first control signal CONT1, a second control signal CONT2, a third control signal CONT3 and data signals DATA based on the input image data IMG and the input control signal CONT.

The timing controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The timing controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The timing controller 200 generates the data signals DATA based on the input image data IMG The timing controller 200 outputs the data signals DATA to the data driver 500.

The timing controller 200 may output a common voltage base signal COM to the data driver 500. In an exemplary embodiment, for example, the timing controller 200 may receive the common voltage base signal COM from outside and output the common voltage base signal COM to the data driver 500.

The timing controller 200 generates the third control signal CONT3 for controlling an operation of the gamma reference voltage generator 400 based on the input control signal CONT, and outputs the third control signal CONT3 to the gamma reference voltage generator 400.

The gate driver 300 generates gate signals driving the gate lines GL in response to the first control signal CONT1 received from the timing controller 200. For example, the gate driver 300 may sequentially output the gate signals to the gate lines GL.

The gate driver 300 may be directly mounted on the display panel 100 or connected to the display panel 100 in a type of a tape carrier package (“TCP”). In another exemplary embodiment, the gate driver 300 may be integrated on the peripheral region of the display panel.

The gamma reference voltage generator 400 generates a gamma reference voltage VGREF in response to the third control signal CONT3 received from the timing controller 200. The gamma reference voltage generator 400 provides the gamma reference voltage VGREF to the data driver 500. The gamma reference voltage VGREF has a value corresponding to a level of the data signal DATA.

In an exemplary embodiment, the gamma reference voltage generator 400 may be disposed in the timing controller 200, or in the data driver 500.

The data driver 500 receives the second control signal CONT2 and the data signals DATA from the timing controller 200, and receives the gamma reference voltages VGREF from the gamma reference voltage generator 400. The data driver 500 converts the data signals DATA into data voltages VD having an analog type using the gamma reference voltages VGREF. The data driver 500 outputs the data voltages VD to the data lines DL.

The data driver 500 may receive the common voltage base signal COM from the timing controller 200. The data driver 500 generates a common voltage VCOM based on the common voltage base signal COM and outputs the common voltage VCOM to the display panel 100.

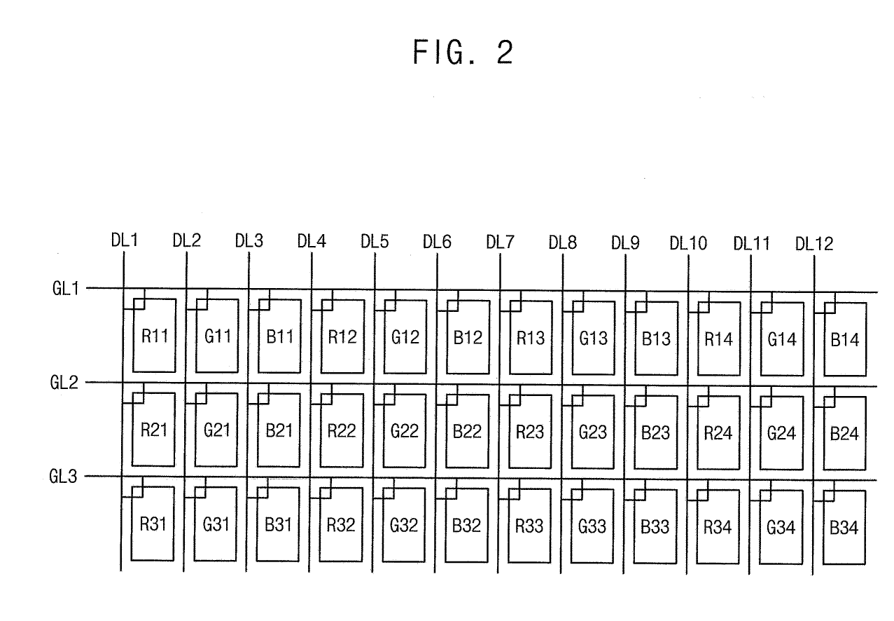

FIG. 2 is a conceptual diagram illustrating an exemplary embodiment of a pixel structure of a display panel of FIG. 1.

Referring to FIGS. 1 and 2, the display panel 100 includes a plurality of subpixels SP disposed in a matrix form.

Subpixels R11, G11, B11, R12, G12, B12, R13, G13, B13, R14, G14 and B14 in a first row of the subpixels SP in the display panel 100 are connected to a first gate line GL1. Subpixels R21, G21, B21, R22, G22, B22, R23, G23, B23, R24, G24 and B24 in a second row of the subpixels SP in the display panel 100 are connected to a second gate line GL2. Subpixels R31, G31, B31, R32, G32, B32, R33, G33, B33, R34, G34 and B34 in a third row of the subpixels SP in the display panel 100 are connected to a third gate line GL3.

Subpixels R11, R21 and R31 in a first column of the subpixels SP in the display panel 100 are connected to a first data line DL1. Subpixels G11, G21 and G31 in a second column of the subpixels SP in the display panel 100 are connected to a second data line DL2. Subpixels B11, B21 and B31 in a third column of the subpixels SP in the display panel 100 are connected to a third data line DL3. Subpixels R12, R22 and R32 in a fourth column of the subpixels SP in the display panel 100 are connected to a fourth data line DL4. Subpixels G12, G22 and G32 in a fifth column of the subpixels SP in the display panel 100 are connected to a fifth data line DL5. Subpixels B12, B22 and B32 in a sixth column of the subpixels SP in the display panel 100 are connected to a sixth data line DL6.

The subpixels having different colors are alternately disposed along a row direction (i.e., first direction D1). In an exemplary embodiment, for example, red, green and blue subpixels are alternately disposed along the row direction.

The subpixels having the same color are disposed along a column direction (i.e., second direction D2). In an exemplary embodiment, for example, the red subpixels are disposed in the first column, the green subpixels are disposed in the second column and the blue subpixels are disposed in the third column.

Although a single data line is connected to the subpixels in the single column (i.e., a non-staggered structure) in this exemplary embodiment, in an alternative exemplary embodiment, a single data line may be connected to the subpixels in two adjacent columns (i.e., a staggered structure).

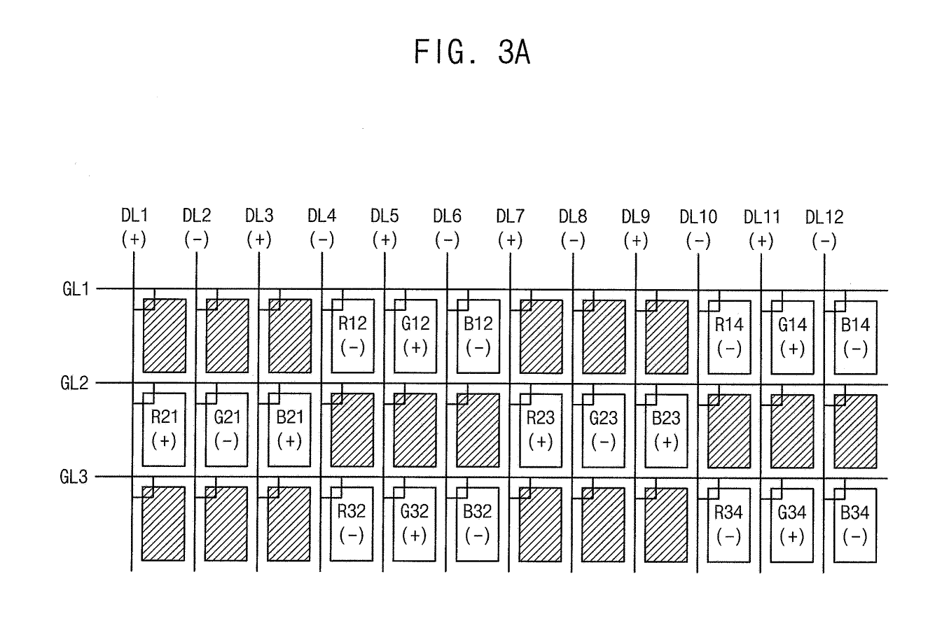

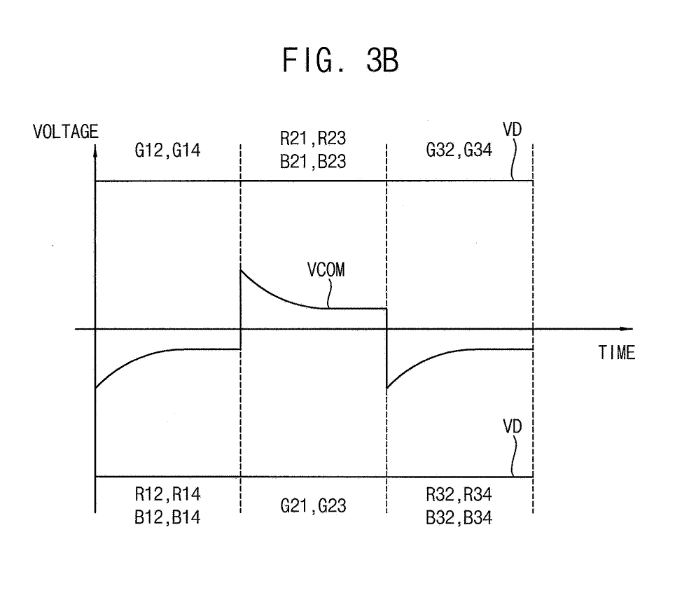

FIG. 3A is a conceptual diagram illustrating an exemplary embodiment of the display panel 100 of FIG. 2 displaying a checker board pattern. FIG. 3B is a timing diagram illustrating an exemplary embodiment of a data voltages VD and a common voltage VCOM when the display panel 100 of FIG. 2 displays the checker board pattern of FIG. 3A.

Referring to FIGS. 1 to 3B, the display panel 100 may display the checker board pattern. In the checker board pattern, three turned-on subpixels and three turned-off subpixels are alternately and repetitively disposed along the row direction and one turned-on subpixel and one turned-off subpixel are alternately and repetitively disposed along the column direction.

In this exemplary embodiment, the display panel 100 is driven in one column inversion method. In the one column inversion method, polarities of the data voltages are inverted every data line (i.e., every column of pixels). In an exemplary embodiment, for example, during a first frame, data voltages applied to first, third, fifth, seventh, ninth and eleventh data lines DL1, DL3, DL5, DL7, DL9 and DL11 may have a first polarity. In contrast, during the first frame, data voltages applied to second, fourth, sixth, eighth, tenth and twelfth data lines DL2, DL4, DL6, DL8, DL10 and DL12 may have a second polarity. During a second frame, data voltages applied to first, third, fifth, seventh, ninth and eleventh data lines DL1, DL3, DL5, DL7, DL9 and DL11 may have the second polarity. In contrast, during the second frame, data voltages applied to second, fourth, sixth, eighth, tenth and twelfth data lines DL2, DL4, DL6, DL8, DL10 and DL12 may have the first polarity.

In a case that the display panel 100 displays the checker board pattern, during a first horizontal period when the gate signal is applied to the subpixels in the first row, the red and blue subpixels R12, R14, B12 and B14, which are turned on, may have data voltages of a negative polarity and the green subpixels G12 and G14, which are turned on, may have data voltages of a positive polarity. During the first horizontal period, the number of the turned-on subpixels R12, R14, B12 and B14 having the data voltages of the negative polarity is greater than the number of the turned-on subpixels G12 and G14 having the data voltages of the positive polarity. Thus, a waveform of the common voltage VCOM may be oriented toward the negative polarity due to a coupling effect.

In the case that the display panel 100 displays the checker board pattern, during a second horizontal period when the gate signal is applied to the subpixels in the second row, the red and blue subpixels R21, R23, B21 and B23, which are turned on, may have data voltages of a positive polarity and the green subpixels G21 and G23, which are turned on, may have data voltages of a negative polarity. During the second horizontal period, the number of the subpixels R21, R23, B21 and B23 having the data voltages of the positive polarity is greater than the number of the subpixels G21 and G23 having the data voltages of the negative polarity. Thus, a waveform of the common voltage VCOM may be oriented toward the positive polarity due to the coupling effect.

As explained above, when the display panel 100 displays the checker board pattern, the common voltage VCOM may have a waveform oscillating between a negative value and a positive value due to the coupling effect as shown in FIG. 3B. Due to the oscillation of the common voltage VCOM, the subpixels may not display the desired grayscales.

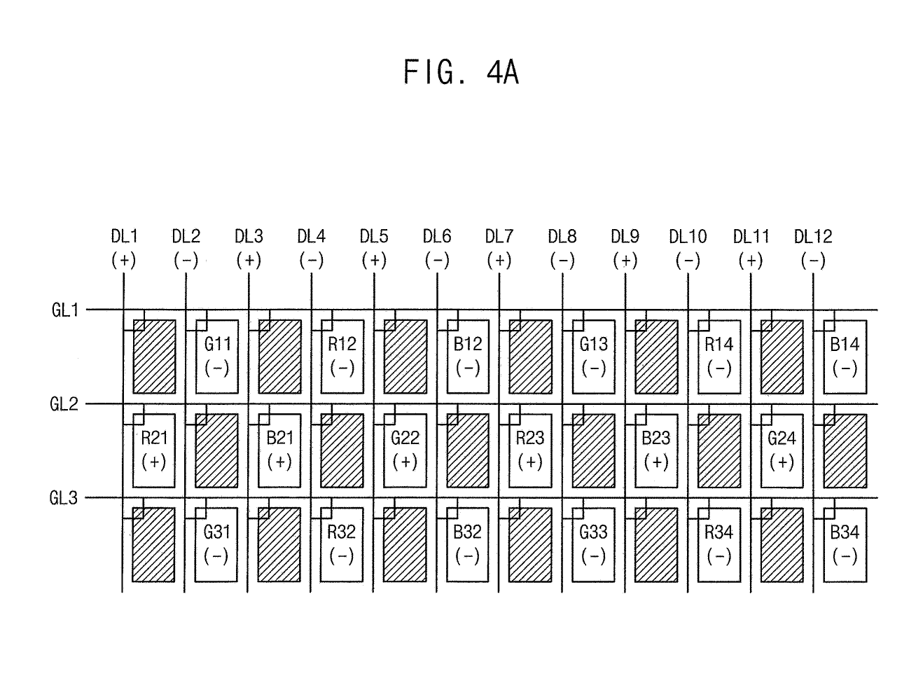

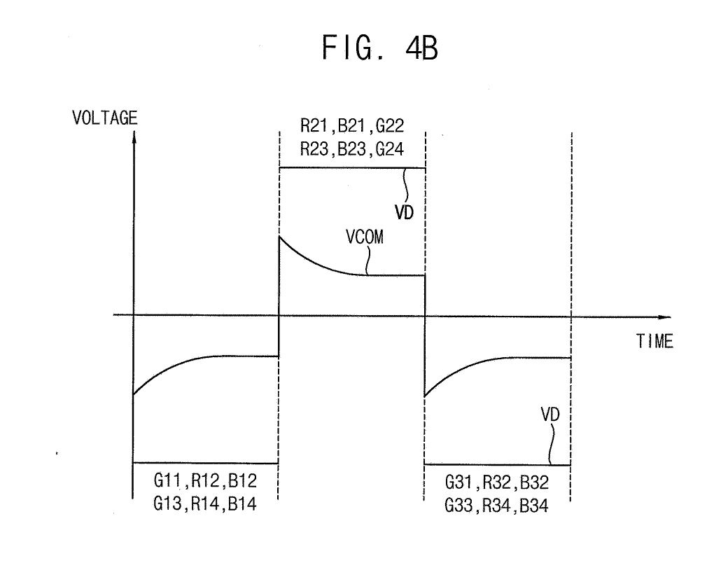

FIG. 4A is a conceptual diagram illustrating an exemplary embodiment of the display panel 100 of FIG. 2 displaying a sub checker board pattern. FIG. 4B is a timing diagram illustrating an exemplary embodiment of data voltages VD and a common voltage VCOM when the display panel 100 of FIG. 2 displays the sub checker board pattern of FIG. 4A.

Referring to FIGS. 1, 2, 4A and 4B, the display panel 100 may display the sub checker board pattern. In the sub checker board pattern, one turned-on subpixel and one turned-off subpixel are alternately and repetitively disposed along the row direction and one turned-on subpixel and one turned-off subpixel are alternately and repetitively disposed along the column direction.

In this exemplary embodiment, the display panel 100 is driven in the one column inversion method.

In a case that the display panel 100 displays the sub checker board pattern, during a first horizontal period when the gate signal is applied to the subpixels in the first row, all of the turned-on subpixels G11, R12, B12, G13, R14 and B14 may have data voltages of a negative polarity. Thus, a waveform of the common voltage VCOM may be oriented toward the negative polarity due to a coupling effect.

In the case that the display panel 100 displays the sub checker board pattern, during a second horizontal period when the gate signal is applied to the subpixels in the second row, all of the turned-on subpixels R21, B21, G22, R23, B23 and G24 may have data voltages of a positive polarity. Thus, a waveform of the common voltage VCOM may be oriented toward the positive polarity due to a coupling effect.

As explained above, when the display panel 100 displays the sub checker board pattern, the common voltage VCOM may have a waveform oscillating between a negative value and a positive value due to the coupling effect as shown in FIG. 4B. Due to the oscillation of the common voltage VCOM, the subpixels may not display the desired grayscales.

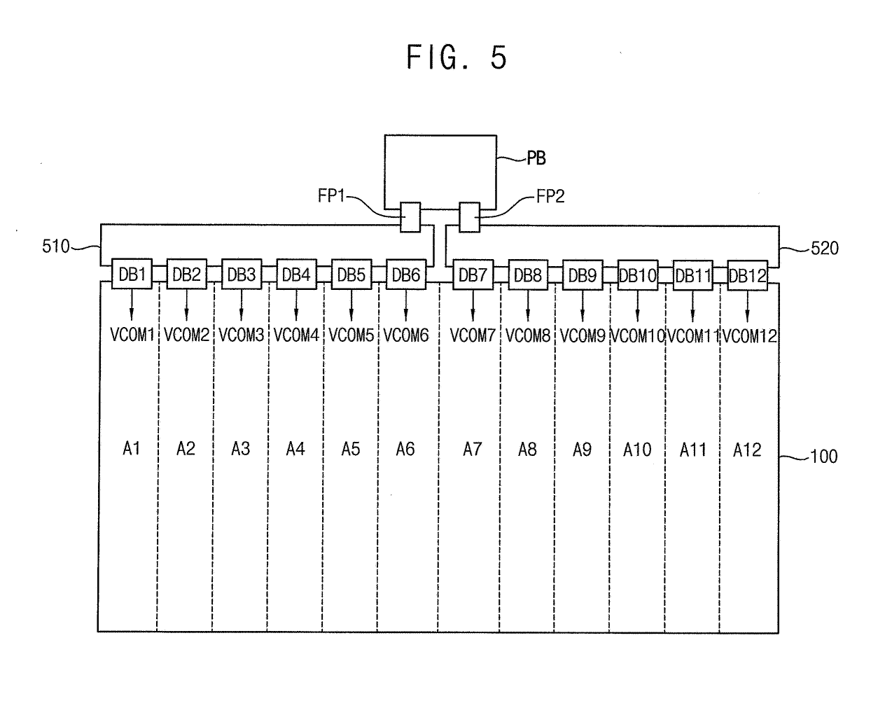

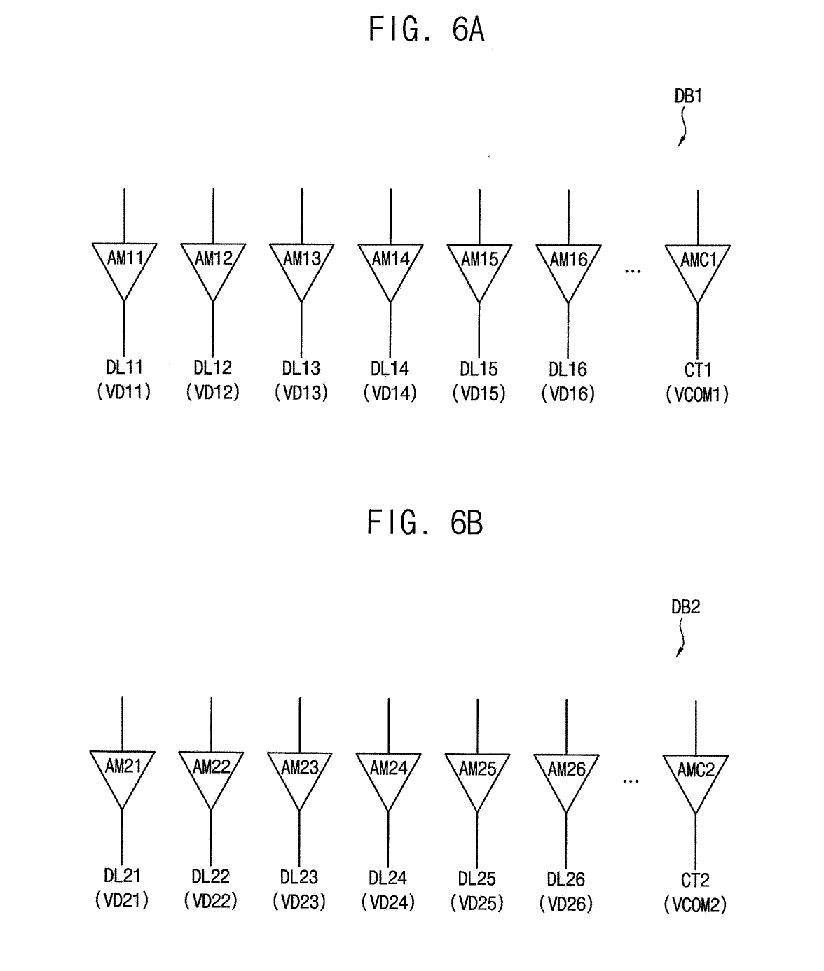

FIG. 5 is a plan view illustrating an exemplary embodiment of the display panel and a data driver of FIG. 1. FIG. 6A is a conceptual diagram illustrating an exemplary embodiment of a first driving block of FIG. 5. FIG. 6B is a conceptual diagram illustrating an exemplary embodiment of a second driving block of FIG. 5.

Referring to FIGS. 1 to 6B, the display panel 100 may include a plurality of display blocks A1 to A12. The display blocks A1 to A12 may extend along an extending direction of the data line DL (i.e., second direction D2). The display blocks A1 to A12 may be arranged along an extending direction of the gate line GL (i.e., first direction D1).

The display panel driver may include a printed circuit board PB, a first data circuit board 510, a second data circuit board 520, a first flexible circuit board FP1 and a second flexible circuit board FP2.

The timing controller 200 may be disposed on the printed circuit board PB. The first data circuit board 510 may be connected to the printed circuit board PB through the first flexible circuit board FP1. The second data circuit board 520 may be connected to the printed circuit board PB through the second flexible circuit board FP2.

The data driver 500 may generate the data voltages VD and output the data voltages VD to the data lines DL of the display panel 100. In addition, the data driver 500 may generate the common voltage VCOM and output the common voltage VCOM to the display panel 100.

The data driver 500 may include a plurality of driving blocks DB1 to DB12. Each of the driving blocks DB1 to DB12 may generate the common voltage VCOM and output the common voltage VCOM to the corresponding display block among the display blocks A1 to A12. The levels of the common voltages VCOM outputted to the driving blocks A1 to A12 may be same as one another. Alternatively, the levels of the common voltages VCOM outputted to the driving blocks A1 to A12 may be different from one another. The levels of the common voltages VCOM outputted from the driving blocks DB1 to DB12 may be adjusted according to lengths of paths transmitting the common voltage VCOM from the driving blocks DB1 to DB12 to the display panel 100. When the path transmitting the common voltage VCOM to a common electrode of the display panel 100 is long, the level of the common voltage VCOM may decrease as transmitting the path. Thus, when the path transmitting the common voltage VCOM to a common electrode of the display panel 100 is relatively long, the corresponding driving block may output the common voltage VCOM having a relatively high level such that the common voltages VCOM arrived to the common electrodes of the display panel 100 by the driving blocks DB1 to DB12 are the same as one another.

The driving blocks DB1 to DB12 may be integrated circuits connected to an end portion of the display panel. The driving blocks DB1 to DB12 may include data flexible circuit boards and the integrated circuits disposed on the data flexible circuit boards.

The driving block may include data voltage amplifiers outputting the data voltages to the data lines DL and at least one common voltage amplifier outputting the common voltage to the display panel 100.

In an exemplary embodiment, for example, a first driving block DB1 may include a plurality of data voltage amplifiers AM11 to AM16 outputting the data voltages VD11 to VD16 to the data lines DL11 to DL16 and a first common voltage amplifier AMC1 outputting the common voltage VCOM1 to a first common electrode CT1 of the display panel 100.

In an exemplary embodiment, for example, a second driving block DB2 may include a plurality of data voltage amplifiers AM21 to AM26 outputting the data voltages VD21 to VD26 to the data lines DL21 to DL26 and a second common voltage amplifier AMC2 outputting the common voltage VCOM2 to a second common electrode CT2 of the display panel 100.

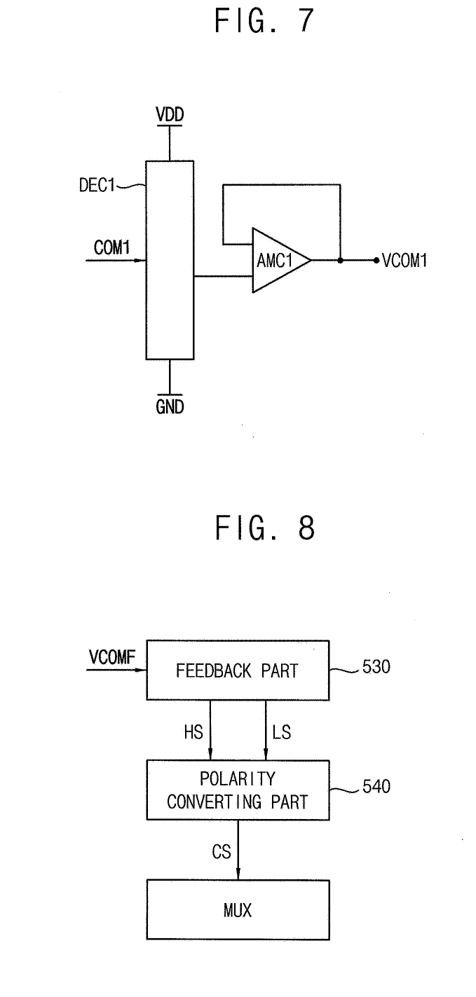

FIG. 7 is a circuit diagram illustrating an exemplary embodiment of a common voltage generator of the first driving block DB1 of FIG. 6A.

Referring to FIGS. 1 to 7, the driving block DB1 to DB12 may further include a decoder receiving the common voltage base signal COM from the timing controller 200 and generating the common voltage VCOM based on the common voltage base signal COM.

Each of the driving blocks DB1 to DB12 may include the decoder. In an exemplary embodiment, for example, the first driving block DB1 may include a first decoder DEC1 receiving a first common voltage base signal COM1 for the first driving block DB1 from the timing controller 200 and generating the first common voltage VCOM1 based on the first common voltage base signal COM1. The first decoder DEC1 may generate the first common voltage VCOM1 between a high-level power voltage VDD and a ground voltage GND based on the first common voltage base signal COM1.

Although not shown in figures, the second driving block DB2 may include a second decoder receiving a second common voltage base signal for the second driving block DB2 from the timing controller 200 and generating the second common voltage VCOM2 based on the second common voltage base signal.

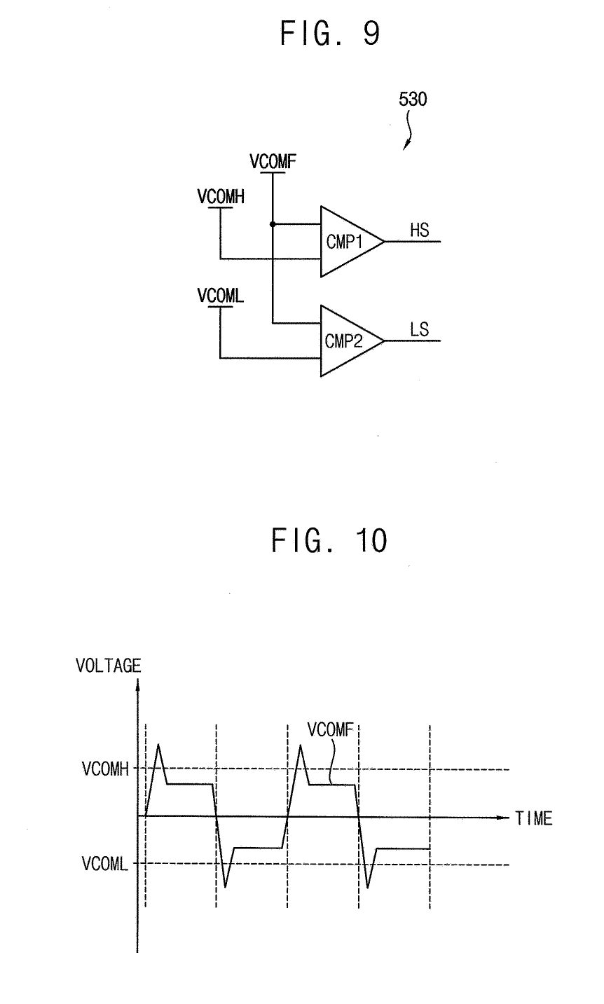

FIG. 8 is a block diagram illustrating an exemplary embodiment of a feedback part 530 and a polarity converting part 540 of the data driver 500 of FIG. 5. FIG. 9 is a circuit diagram illustrating an exemplary embodiment of the feedback part 530 of FIG. 8. FIG. 10 is a timing diagram illustrating an exemplary embodiment of a waveform of a fed-back common voltage VCOMF of FIG. 9.

Referring to FIGS. 1 to 10, the data driver 500 may include the feedback part 530 and the polarity converting part 540. The feedback part 530 may compare the fed-back common voltage VCOMF from the display panel 100 with reference voltages VCOMH and VCOML to generate comparing signals HS and LS. The polarity converting part 540 may convert the polarity inversion driving method of the display panel 100 based on the comparing signals HS and LS.

For example, each of the driving blocks DB1 to DB12 may include the feedback part 530 and the polarity converting part 540. In an exemplary embodiment, for example, the first driving block DB1 compares a fed-back common voltage from the first display block A1 with the reference voltages VCOMH and VCOML, generates the comparing signals HS and LS and converts the polarity inversion driving method of the first display block Al based on the comparing signals HS and LS. For example, the second driving block DB2 compares a fed-back common voltage from the second display block A2 with the reference voltages VCOMH and VCOML, generates the comparing signals HS and LS and converts the polarity inversion driving method of the second display block A2 based on the comparing signal HS and LS. As a result, the display blocks A1 to A12 may be driven in different polarity inversion driving methods.

In an exemplary embodiment, for example, the feedback part 530 may include a first comparator CMP1 and a second comparator CMP2. The first comparator CMP1 may include a first input terminal receiving the fed-back common voltage VCOMF, a second input terminal receiving a first reference voltage VCOMH which is greater than a target common voltage and an output terminal outputting a first comparing signal HS when the fed-back common voltage VCOMF is greater than the first reference voltage VCOMH. The second comparator CMP2 may include a first input terminal receiving the fed-back common voltage VCOMF, a second input terminal receiving a second reference voltage VCOML which is less than the target common voltage and an output terminal outputting a second comparing signal LS when the fed-back common voltage VCOMF is less than the second reference voltage VCOML.

In an exemplary embodiment, for example, the first reference voltage VCOMH and the second reference voltage VCOML may represent a tolerance range of the common voltage VCOM. For example, the first reference voltage VCOMH may mean an upper limit of the tolerance range of the common voltage VCOM and the second reference voltage VCOML may mean a lower limit of the tolerance range of the common voltage VCOM. When the fed-back common voltage VCOMF is greater than the first reference voltage VCOMH, the first comparing signal HS representing that the fed-back common voltage VCOMF exceeds the upper limit of the tolerance range of the common voltage VCOM may be outputted. When the fed-back common voltage VCOMF is less than the second reference voltage VCOML, the second comparing signal LS representing that the fed-back common voltage VCOMF exceeds the lower limit of the tolerance range of the common voltage VCOM may be outputted.

When the first comparing signal HS or the second comparing signal LS is received, the polarity converting part 540 may convert the polarity inversion driving method of the display panel 100. In an alternative embodiment, when both the first comparing signal HS and the second comparing signal LS are received, the polarity converting part 540 may convert the polarity inversion driving method of the display panel 100. For example, the polarity converting part 540 may output a mode determining signal CS to convert the polarity of the display panel 100 based on the first comparing signal HS and the second comparing signal LS.

In an exemplary embodiment, for example, the polarity inversion driving methods may include a first mode and a second mode. The polarity converting part 540 may convert the polarity inversion driving methods between the first mode and the second mode according to the comparing signals HS and LS.

In another exemplary embodiment, for example, the polarity inversion driving methods may include the first mode, the second mode and a third mode. The polarity converting part 540 may convert the polarity inversion driving methods among the first mode, the second mode and the third mode according to the comparing signals HS and LS.

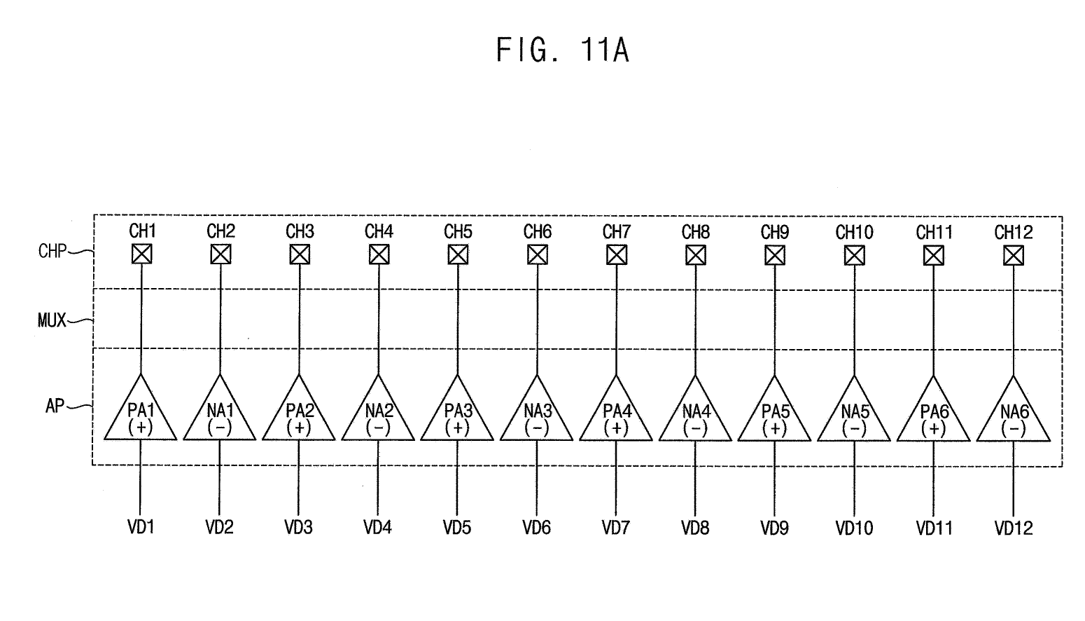

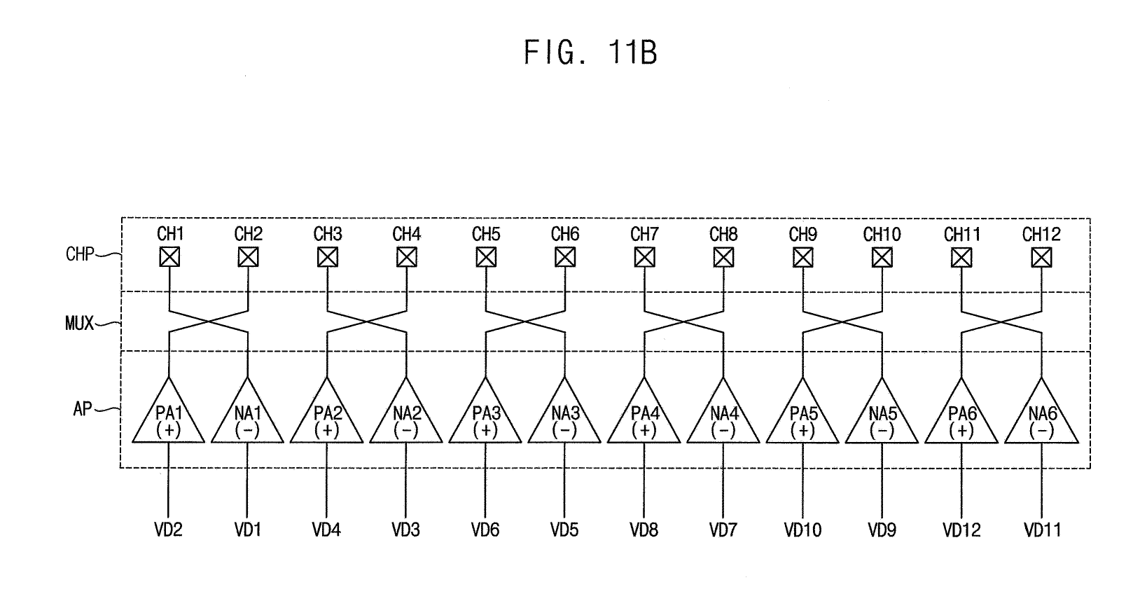

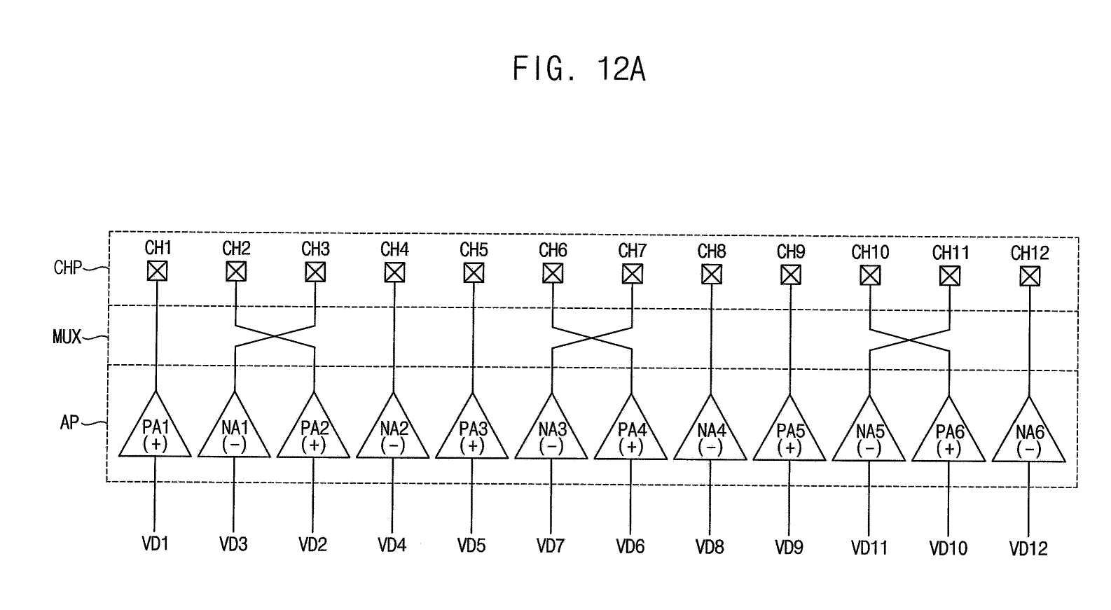

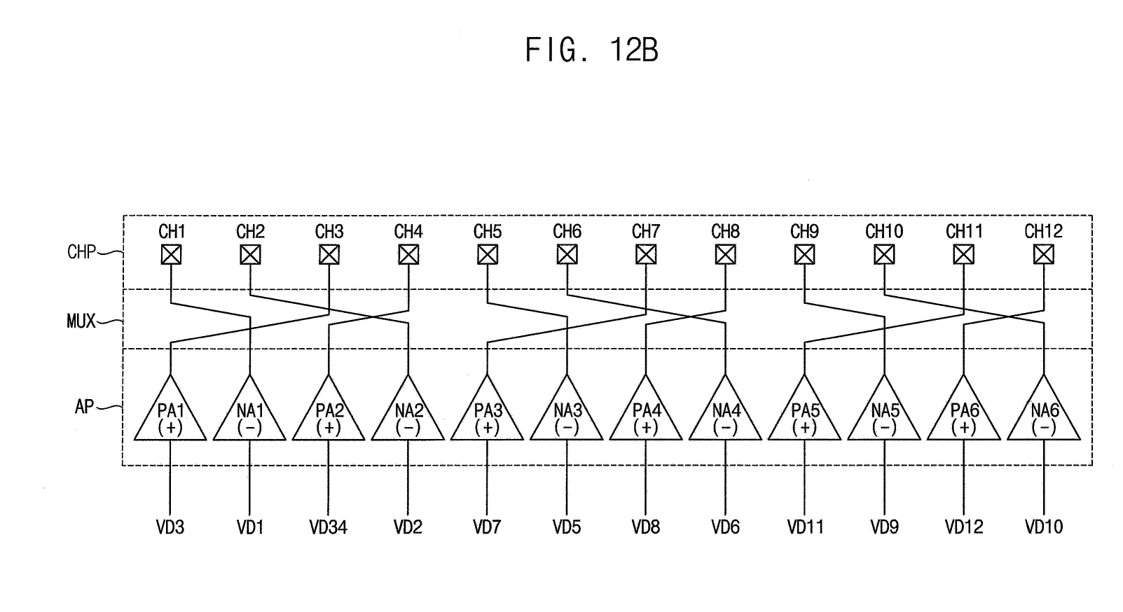

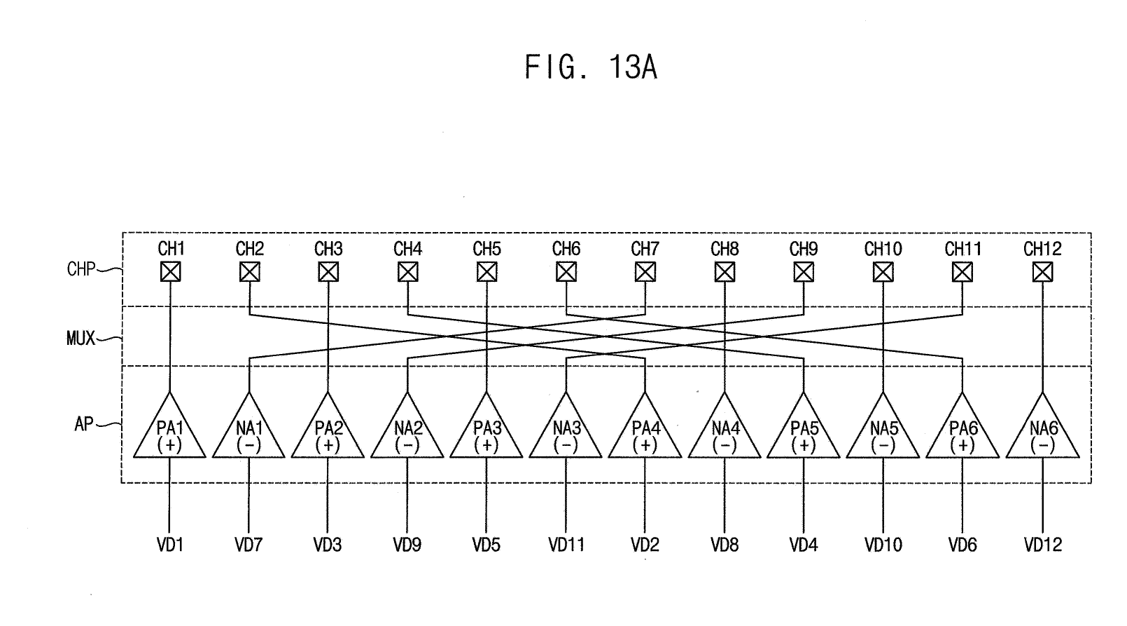

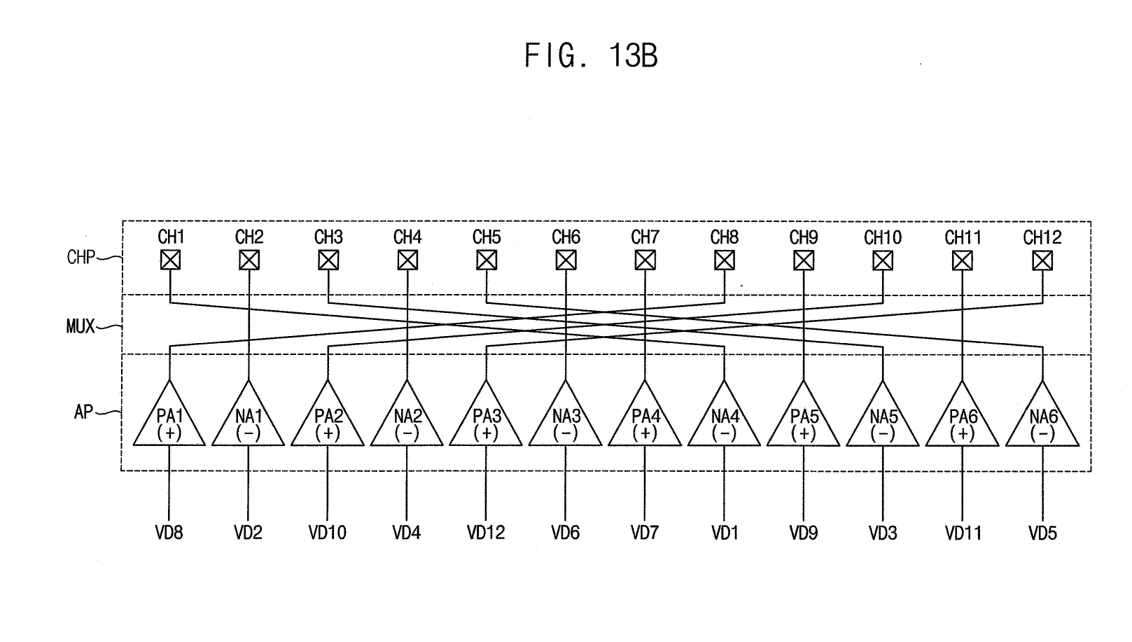

FIGS. 11A and 11B are conceptual diagrams illustrating an exemplary embodiment of a polarity inversion driving method of a first mode. FIGS. 12A and 12B are conceptual diagrams illustrating an exemplary embodiment of a polarity inversion driving method of a second mode. FIGS. 13A and 13B are conceptual diagrams illustrating an exemplary embodiment of a polarity inversion driving method of a third mode.

Referring to FIGS. 1 to 13B, the first mode may be an inversion method in which polarities of the data voltages are inverted every data line such as one column inversion method and one dot inversion method. Particularly, in the one dot inversion method, polarities of the data voltages are inverted every subpixel. The second mode may be an inversion method in which polarities of the data voltages are inverted every two data lines such as a two-columns inversion method and a two-by-one inversion method. Particularly, in the two-by-one dot inversion method, polarities of the data voltages are inverted every two data lines in the first direction D1 and every subpixel in the second direction D2. The third mode may be an inversion method in which polarities of the data voltages are inverted every six data lines such as a six-columns inversion method and a six-by-one inversion method. Particularly, in the six-by-one dot inversion method, polarities of the data voltages are inverted every six data lines in the first direction D1 and every subpixel in the second direction D2. When the display panel 100 has the non-staggered structure, the first to third modes may be the one column inversion method, the two columns inversion method and the six columns inversion method, respectively. When the display panel 100 has the staggered structure, the first to third modes may be the one dot inversion method, the two-by-one inversion method and the six by one inversion method, respectively.

The data driver 500 may include an amplifying part AP including a plurality of data voltage amplifiers PA1 to PA6 and NA1 to NA6, a data channel part CHP including a plurality of data channels CH1 to CH12 and a multiplexer MUX disposed between the amplifying part AP and the data channel part CHP and determining connections between the data voltage amplifiers PA1 to PA6 and NA1 to NA6 and the data channels CH1 to CH12.

The polarity converting part 540 may output the mode determining signal CS to the multiplexer MUX to convert the polarity inversion driving mode of the display panel 100.

The amplifying part AP may include positive data voltage amplifiers PA1 to PA6 and negative data voltage amplifiers NA1 to NA6. The positive data voltage amplifiers PA1 to PA6 and the negative data voltage amplifiers NA1 to NA6 may be alternately disposed each other as shown in FIG. 11A.

FIG. 11A may represent a polarity structure of the data driver 500 in a first frame in the first mode. FIG. 11B may represent a polarity structure of the data driver 500 in a second frame in the first mode.

As shown in FIG. 11A, positive data voltages are outputted to first, third, fifth, seventh, ninth and eleventh data channels CH1, CH3, CH5, CH7, CH9 and CH11 and negative data voltages are outputted to second, fourth, sixth, eighth, tenth and twelfth data channels CH2, CH4, CH6, CH8, CH10 and CH12 in the first frame in the first mode by the operation of the multiplexer MUX.

As shown in FIG. 11B, negative data voltages are outputted to first, third, fifth, seventh, ninth and eleventh data channels CH1, CH3, CH5, CH7, CH9 and CH11 and positive data voltages are outputted to second, fourth, sixth, eighth, tenth and twelfth data channels CH2, CH4, CH6, CH8, CH10 and CH12 in the second frame in the first mode by the operation of the multiplexer MUX.

FIG. 12A may represent a polarity structure of the data driver 500 in a first frame in the second mode. FIG. 12B may represent a polarity structure of the data driver 500 in a second frame in the second mode.

As shown in FIG. 12A, positive data voltages are outputted to first, second, fifth, sixth, ninth and tenth data channels CH1, CH2, CH5, CH6, CH9 and CH10 and negative data voltages are outputted to third, fourth, seventh, eighth, eleventh and twelfth data channels CH3, CH4, CH7, CH8, CH11 and CH12 in the first frame in the second mode by the operation of the multiplexer MUX.

As shown in FIG. 12B, negative data voltages are outputted to first, second, fifth, sixth, ninth and tenth data channels CH1, CH2, CH5, CH6, CH9 and CH10 and positive data voltages are outputted to third, fourth, seventh, eighth, eleventh and twelfth data channels CH3, CH4, CH7, CH8, CH11 and CH12 in the second frame in the second mode by the operation of the multiplexer MUX.

FIG. 13A may represent a polarity structure of the data driver 500 in a first frame in the third mode. FIG. 13B may represent a polarity structure of the data driver 500 in a second frame in the third mode.

As shown in FIG. 13A, positive data voltages are outputted to first, second, third, fourth, fifth and sixth data channels CH1, CH2, CH3, CH4, CH5 and CH6 and negative data voltages are outputted to seventh, eighth, ninth, tenth, eleventh and twelfth data channels CH7, CH8, CH9, CH10, CH11 and CH12 in the first frame in the third mode by the operation of the multiplexer MUX.

As shown in FIG. 13B, negative data voltages are outputted to first, second, third, fourth, fifth and sixth data channels CH1, CH2, CH3, CH4, CH5 and CH6 and positive data voltages are outputted to seventh, eighth, ninth, tenth, eleventh and twelfth data channels CH7, CH8, CH9, CH10, CH11 and CH12 in the second frame in the third mode by the operation of the multiplexer MUX. In addition to the operation of the multiplexer MUX changing connections between the data voltage amplifiers and the data channels, the arrangement of the data voltages VD1 to VD12 may change such that only the polarity of the data voltage supplied to each data channel is changed without changing of the amplitude of the data voltage thereof even if the modes (inversion methods) are changed as shown in FIGS. 11A to 13B.

Referring again to FIGS. 3A and 3B, during the first horizontal period when the gate signal is applied to the subpixels in the first row, if in the first mode (i.e., one-column inversion method), the turned-on subpixels R12, G12, B12, R14, G14 and B14 may have data voltages of (−), (+), (−), (−), (+) and (−) such that the common voltage VCOM may be oriented toward the negative polarity in the first row. Here, (−) means that the corresponding voltage has a negative value, and (+) means that the corresponding voltage has a positive value.

However, during the first horizontal period when the gate signal is applied to the subpixels in the first row, if in the second mode (i.e., two-columns inversion method), the turned-on subpixels R12, G12, B12, R14, G14 and B14 may have data voltages of (−), (+), (+), (+), (−) and (−) such that the polarity of the common voltage VCOM may be in equilibrium in the first row. In the similar way, during the second horizontal period when the gate signal is applied to the subpixels in the second row, the polarity of the common voltage VCOM may be in equilibrium in the second row in the second mode (i.e., two-columns inversion method).

In addition, during the first horizontal period when the gate signal is applied to the subpixels in the first row, if in the third mode (i.e., six columns inversion method), the turned-on subpixels R12, G12, B12, R14, G14 and B14 may have data voltages of (+), (+), (+), (−), (−) and (−) such that the polarity of the common voltage VCOM may be in equilibrium in the first row. In the similar way, during the second horizontal period when the gate signal is applied to the subpixels in the second row, the polarity of the common voltage VCOM may be in equilibrium in the second row in the third mode.

Referring again to FIGS. 4A and 4B, during the first horizontal period when the gate signal is applied to the subpixels in the first row, the turned-on subpixels G11, R12, B12, G13, R14 and B14 may have data voltages of (−), (−), (−), (−), (−) and (−) such that the common voltage VCOM may be oriented toward the negative polarity in the first row in the first mode.

However, during the first horizontal period when the gate signal is applied to the subpixels in the first row, if in the second mode, the turned-on subpixels G11, R12, B12, G13, R14 and B14 may have data voltages of (+), (−), (+), (−), (+) and (−) such that the polarity of the common voltage VCOM may be in equilibrium in the first row. In the similar way, during the second horizontal period when the gate signal is applied to the subpixels in the second row, the polarity of the common voltage VCOM may be in equilibrium in the second row in the second mode.

In addition, during the first horizontal period when the gate signal is applied to the subpixels in the first row, if in the third mode, the turned-on subpixels G11, R12, B12, G13, R14 and B14 may have data voltages of (+), (+), (+), (−), (−) and (−) such that the polarity of the common voltage VCOM may be in equilibrium in the first row. In the similar way, during the second horizontal period when the gate signal is applied to the subpixels in the second row, the polarity of the common voltage VCOM may be in equilibrium in the second row in the third mode.

For example, the polarity converting part 540 may convert the polarity inversion driving method between the first mode and the second mode according to the comparing signals HS and LS or the mode determining signal CS which is generated based on the comparing signals HS and LS. In an exemplary embodiment, polarities of the data voltages are inverted every data line in the first mode and polarities of the data voltages are inverted every two data lines in the second mode. In another exemplary embodiment, polarities of the data voltages are inverted every data line in the first mode and polarities of the data voltages are inverted every six data lines in the second mode. In still another exemplary embodiment, polarities of the data voltages are inverted every two data lines in the first mode and polarities of the data voltages are inverted every six data lines in the second mode.

For example, the polarity converting part 540 may convert the polarity inversion driving method among the first mode, the second mode and the third mode according to the comparing signals HS and LS or the mode determining signal CS which is generated based on the comparing signals HS and LS. In an exemplary embodiment, polarities of the data voltages are inverted every data line in the first mode, polarities of the data voltages are inverted every two data lines in the second mode and polarities of the data voltages are inverted every six data lines in the second mode.

However, the polarity inversion driving method of the display panel 100 may not be limited to the one column inversion method, the two columns inversion method and the six columns inversion method.

According to the above exemplary embodiments, the driving blocks DB1 to DB12 of the data driver 500 generates the common voltages and outputs the common voltages to the display blocks A1 to A12 of display panel 100 such that the uniformity of the common voltage VCOM may be enhanced.

In addition, by converting the polarity inversion driving method of the display panel 100 using a waveform of the fed-back common voltage VCOMF when the distortion of the common voltage VCOM occurs, the distortion of the common voltage VCOM may be reduced.

As a result, the level of the common voltage VCOM may be stabilized such that the display quality of the display panel 100 may be enhanced.

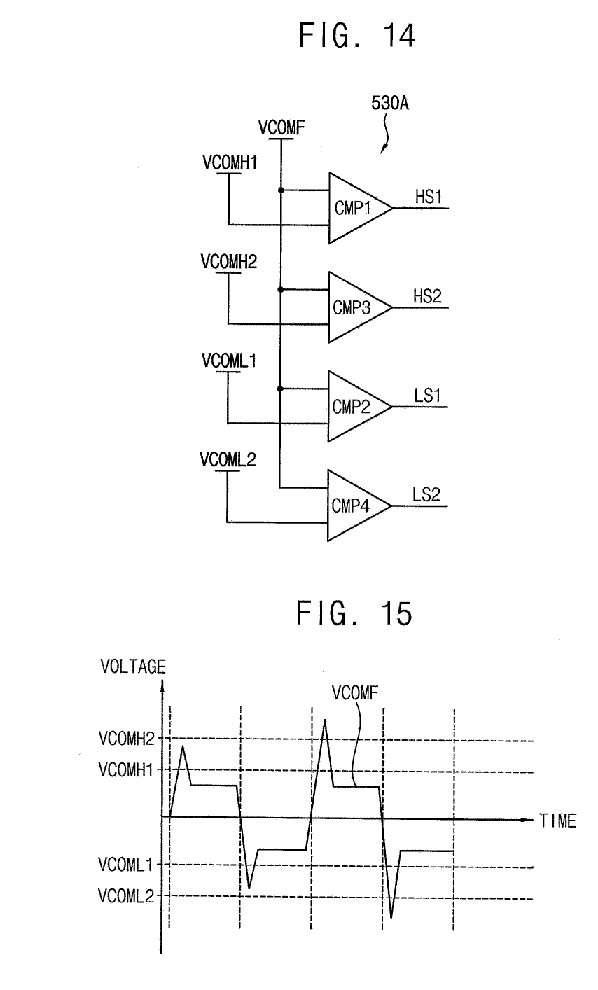

FIG. 14 is a circuit diagram illustrating an exemplary embodiment of a feedback part 530A of a data driver 500 of a display apparatus according to the inventive concept. FIG. 15 is a timing diagram illustrating an exemplary embodiment of a waveform of a fed-back common voltage VCOMF of FIG. 14.

The display apparatus according to the exemplary embodiment is substantially the same as the display apparatus of the exemplary embodiments explained referring to FIGS. 1 to 13B except for the structure of the feedback part. Thus, the same reference numerals will be used to refer to the same or like parts as those described in the exemplary embodiments of FIGS. 1 to 13B and any repetitive explanation concerning the above elements will be omitted.

Referring to FIGS. 1 to 8 and 11A to 15, the display apparatus includes a display panel 100 and a display panel driver. The display panel driver includes a timing controller 200, a gate driver 300, a gamma reference voltage generator 400 and a data driver 500.

The data driver 500 receives the second control signal CONT2 and the data signals DATA from the timing controller 200, and receives the gamma reference voltages VGREF from the gamma reference voltage generator 400. The data driver 500 converts the data signals DATA into data voltages VD having an analog type using the gamma reference voltages VGREF. The data driver 500 outputs the data voltages VD to the data lines DL.

The data driver 500 may receive the common voltage base signal COM from the timing controller 200. The data driver 500 generates a common voltage VCOM based on the common voltage base signal COM and outputs the common voltage VCOM to the display panel 100.

The data driver 500 may include the feedback part 530A and the polarity converting part 540. The feedback part 530A may compare the fed-back common voltage VCOMF from the display panel 100 with a reference voltage VCOMH1, VCOMH2, VCOML1 and VCOML2 to generate comparing signals HS1, HS2, LS1 and LS2. The polarity converting part 540 may convert the polarity inversion driving method of the display panel 100 based on the comparing signals HS1, HS2, LS1 and LS2.

For example, each of the driving blocks DB1 to DB12 may include the feedback part 530A and the polarity converting part 540.

In an exemplary embodiment, for example, the feedback part 530A may include a first comparator CMP1, a second comparator CMP2, a third comparator CMP3 and a fourth comparator CMP4.

The first comparator CMP1 may include a first input terminal receiving the fed-back common voltage VCOMF, a second input terminal receiving a first reference voltage VCOMH1 which is greater than a target common voltage and an output terminal outputting a first comparing signal HS1 when the fed-back common voltage VCOMF is greater than the first reference voltage VCOMH1.

The second comparator CMP2 may include a first input terminal receiving the fed-back common voltage VCOMF, a second input terminal receiving a second reference voltage VCOML1 which is less than the target common voltage and an output terminal outputting a second comparing signal LS1 when the fed-back common voltage VCOMF is less than the second reference voltage VCOML1.

The third comparator CMP3 may include a first input terminal receiving the fed-back common voltage VCOMF, a second input terminal receiving a third reference voltage VCOMH2 which is greater than the first reference voltage VCOMH1 and an output terminal outputting a third comparing signal HS2 when the fed-back common voltage VCOMF is greater than the third reference voltage VCOMH2.

The fourth comparator CMP4 may include a first input terminal receiving the fed-back common voltage VCOMF, a second input terminal receiving a fourth reference voltage VCOML2 which is less than the second reference voltage VCOML1 and an output terminal outputting a fourth comparing signal LS2 when the fed-back common voltage VCOMF is less than the fourth reference voltage VCOML2.

In an exemplary embodiment, for example, the first reference voltage VCOMH1 and the second reference voltage VCOML1 may represent a first tolerance range of the common voltage VCOM. For example, the first reference voltage VCOMH1 may mean an upper limit of the first tolerance range of the common voltage VCOM and the second reference voltage VCOML1 may mean a lower limit of the first tolerance range of the common voltage VCOM.

In an exemplary embodiment, for example, the third reference voltage VCOMH2 and the fourth reference voltage VCOML2 may represent a second tolerance range of the common voltage VCOM. For example, the third reference voltage VCOMH2 may mean an upper limit of the second tolerance range of the common voltage VCOM and the fourth reference voltage VCOML2 may mean a lower limit of the second tolerance range of the common voltage VCOM.

When the first comparing signal HS1 or the second comparing signal LS1 is received, the polarity converting part 540 may convert the polarity inversion driving method of the display panel 100. When the third comparing signal HS2 or the fourth comparing signal LS2 is received, the polarity converting part 540 may convert the polarity inversion driving method of the display panel 100 in a different way from when the first comparing signal HS1 or the second comparing signal LS1 is received.

In an exemplary embodiment, for example, the polarity inversion driving methods may include a first mode and a second mode. The polarity converting part 540 may convert the polarity inversion driving methods between the first mode and the second mode according to the comparing signal HS1, LS1, HS2 and LS2.

In another exemplary embodiment, for example, the polarity inversion driving methods may include the first mode, the second mode and a third mode. The polarity converting part 540 may convert the polarity inversion driving methods among the first mode, the second mode and the third mode according to the comparing signal HS1, LS1, HS2 and LS2.

In this way, the data driver 500 may manage the distortion of the common voltage VCOM in various levels. The data driver 500 may differently convert the polarity inversion driving methods of the display panel 100 according to the degree of the distortion of the common voltage VCOM to compensate the distortion of the common voltage VCOM.

According to an exemplary embodiment, the driving blocks DB1 to DB12 of the data driver 500 generates the common voltages and outputs the common voltages to the display blocks A1 to A12 of display panel 100 such that the uniformity of the common voltage VCOM may be enhanced.

In addition, by converting the polarity inversion driving method of the display panel 100 using a waveform of the fed-back common voltage VCOMF when the distortion of the common voltage VCOM occurs, the distortion of the common voltage VCOM may be reduced.

As a result, the level of the common voltage VCOM may be stabilized such that the display quality of the display panel 100 may be enhanced.

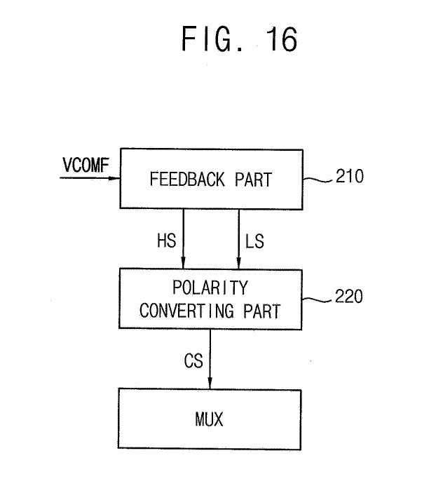

FIG. 16 is a block diagram illustrating an exemplary embodiment of a feedback part 210 and a polarity converting part 220 of a timing controller 200 of a display apparatus according to the inventive concept.

The display apparatus according to the exemplary embodiment is substantially the same as the display apparatus of the exemplary embodiments explained referring to FIGS. 1 to 13B except that the timing controller 200 includes the feedback part 210 and the polarity converting part 220. Thus, the same reference numerals will be used to refer to the same or like parts as those described in the previous exemplary embodiment of FIGS. 1 to 13B and any repetitive explanation concerning the above elements will be omitted.

Referring to FIGS. 1 to 7, 9 to 13B and 16, the display apparatus includes a display panel 100 and a display panel driver. The display panel driver includes a timing controller 200, a gate driver 300, a gamma reference voltage generator 400 and a data driver 500.

The data driver 500 receives the second control signal CONT2 and the data signals DATA from the timing controller 200, and receives the gamma reference voltages VGREF from the gamma reference voltage generator 400. The data driver 500 converts the data signals DATA into data voltages VD having an analog type using the gamma reference voltages VGREF. The data driver 500 outputs the data voltages VD to the data lines DL.

The data driver 500 may receive the common voltage base signal COM from the timing controller 200. The data driver 500 generates a common voltage VCOM based on the common voltage base signal COM and outputs the common voltage VCOM to the display panel 100.

The timing controller 200 may include the feedback part 210 and the polarity converting part 220. The feedback part 210 may compare the fed-back common voltage VCOMF from the display panel 100 with a reference voltage VCOMH and VCOML to generate comparing signals HS and LS. The polarity converting part 220 may convert the polarity inversion driving method of the display panel 100 based on the comparing signals HS and LS.

For example, the timing controller 200 may include a plurality of the feedback parts 210 and a plurality of the polarity converting parts 220 corresponding to the plurality of the display blocks A1 to A12.

Alternatively, the timing controller 200 may include the single feedback part 210 and the single polarity converting part 220.

In an exemplary embodiment, for example, the feedback part 210 may include a first comparator CMP1 and a second comparator CMP2. The first comparator CMP1 may include a first input terminal receiving the fed-back common voltage VCOMF, a second input terminal receiving a first reference voltage VCOMH which is greater than a target common voltage and an output terminal outputting a first comparing signal HS when the fed-back common voltage VCOMF is greater than the first reference voltage VCOMH. The second comparator CMP2 may include a first input terminal receiving the fed-back common voltage VCOMF, a second input terminal receiving a second reference voltage VCOML which is less than the target common voltage and an output terminal outputting a second comparing signal LS when the fed-back common voltage VCOMF is less than the second reference voltage VCOML.

When the first comparing signal HS or the second comparing signal LS is received, the polarity converting part 220 may convert the polarity inversion driving method of the display panel 100. Alternatively, when both the first comparing signal HS and the second comparing signal LS are received, the polarity converting part 220 may convert the polarity inversion driving method of the display panel 100. For example, the polarity converting part 220 may output a mode determining signal CS to convert the polarity of the display panel 100 based on the first comparing signal HS and the second comparing signal LS.

In an exemplary embodiment, for example, the polarity inversion driving methods may include a first mode and a second mode. The polarity converting part 220 may convert the polarity inversion driving methods between the first mode and the second mode according to the comparing signals HS and LS.

In another exemplary embodiment, for example, the polarity inversion driving methods may include the first mode, the second mode and a third mode. The polarity converting part 220 may convert the polarity inversion driving methods among the first mode, the second mode and the third mode according to the comparing signals HS and LS.

The polarity converting part 220 may output the mode determining signal CS to the multiplexer MUX to convert the polarity inversion driving mode of the display panel 100.

According to an exemplary embodiment, the driving blocks DB1 to DB12 of the data driver 500 generates the common voltages and outputs the common voltages to the display blocks A1 to A12 of display panel 100 such that the uniformity of the common voltage VCOM may be enhanced.

In addition, by converting the polarity inversion driving method of the display panel 100 using a waveform of the fed-back common voltage VCOMF when the distortion of the common voltage VCOM is generated, the distortion of the common voltage VCOM may be reduced.

As a result, the level of the common voltage VCOM may be stabilized such that the display quality of the display panel 100 may be enhanced.

According to exemplary embodiments of the display apparatus and the method of driving the display panel, the level of the common voltage is stabilized such that the display quality of the display panel may be enhanced.

The foregoing is illustrative of the inventive concept and is not to be construed as limiting thereof. Although a few exemplary embodiments of the inventive concept have been described, those skilled in the art will readily appreciate that many modifications are possible in the exemplary embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the specific exemplary embodiments disclosed, and that modifications to the disclosed exemplary embodiments, as well as other exemplary embodiments, are intended to be included within the scope of the appended claims. The inventive concept is defined by the following claims, with equivalents of the claims to be included therein.

What is claimed is:

1. A display apparatus comprising:
a display panel including a plurality of display blocks;
a gate driver which generates a plurality of gate signals and outputs the plurality of the gate signals to a plurality of gate lines; and
a data driver which generates a plurality of data voltages, outputs the plurality of the data voltages to a plurality of data lines, generates common voltages and outputs the common voltages to the display panel,
wherein the data driver comprises a plurality of driving blocks, and the driving blocks generate the common voltages and output the common voltages to the display blocks.

2. The display apparatus of claim 1, wherein the display blocks extend along an extending direction of the data lines, and
the display blocks are arranged along an extending direction of the gate lines.

3. The display apparatus of claim 1, wherein the driving blocks are respectively integrated circuits connected to an end portion of the display panel.

4. The display apparatus of claim 1, wherein the driving block comprises:
a plurality of data voltage amplifiers which outputs the data voltages to the data lines; and
at least one common voltage amplifier which outputs the common voltage to the display panel.

5. The display apparatus of claim 4, wherein the driving block further comprises a decoder which receives a common voltage base signal from a timing controller and generates the common voltage based on the common voltage base signal.

6. The display apparatus of claim 5, wherein the driving block further comprises:
a feedback part which compares a fed-back common voltage from the display panel with a reference voltage and generates a comparing signal; and
a polarity converting part which converts a polarity inversion driving method of the display panel based on the comparing signal.

7. The display apparatus of claim 6, wherein the feedback part comprises:
a first comparator comprising a first input terminal receiving the fed-back common voltage, a second input terminal receiving a first reference voltage which is greater than a target common voltage and an output terminal outputting a first comparing signal when the fed-back common voltage is greater than the first reference voltage; and
a second comparator comprising a first input terminal receiving the fed-back common voltage, a second input terminal receiving a second reference voltage which is less than the target common voltage and an output terminal outputting a second comparing signal when the fed-back common voltage is less than the second reference voltage.

8. The display apparatus of claim 6, wherein the feedback part comprises:
a first comparator comprising a first input terminal receiving the fed-back common voltage, a second input terminal receiving a first reference voltage which is greater than a target common voltage and an output terminal outputting a first comparing signal when the fed-back common voltage is greater than the first reference voltage;
a second comparator comprising a first input terminal receiving the fed-back common voltage, a second input terminal receiving a second reference voltage which is less than the target common voltage and an output terminal outputting a second comparing signal when the fed-back common voltage is less than the second reference voltage;
a third comparator comprising a first input terminal receiving the fed-back common voltage, a second input terminal receiving a third reference voltage which is greater than the first reference voltage and an output terminal outputting a third comparing signal when the fed-back common voltage is greater than the third reference voltage; and
a fourth comparator comprising a first input terminal receiving the fed-back common voltage, a second input terminal receiving a fourth reference voltage which is less than the second reference voltage and an output terminal outputting a fourth comparing signal when the fed-back common voltage is less than the fourth reference voltage.

9. The display apparatus of claim 6, wherein the driving block further comprises a multiplexer disposed between the data voltage amplifiers and the data lines and which determines connections between the data voltage amplifiers and the data lines.

10. The display apparatus of claim 6, wherein the polarity inversion driving method comprises a first mode and a second mode,
the polarity converting part converts the polarity inversion driving method between the first mode and the second mode according to the comparing signal,
polarities of the data voltages are inverted every data line in the first mode, and
the polarities of the data voltages are inverted every two data lines in the second mode.

11. The display apparatus of claim 6, wherein the polarity inversion driving method comprises a first mode and a second mode,
the polarity converting part converts the polarity inversion driving method between the first mode and the second mode according to the comparing signal,
polarities of the data voltages are inverted every data line in the first mode, and
the polarities of the data voltages are inverted every six data lines in the second mode.

12. The display apparatus of claim 6, wherein the polarity inversion driving method comprises a first mode and a second mode,
the polarity converting part converts the polarity inversion driving method between the first mode and the second mode according to the comparing signal,
polarities of the data voltages are inverted every two data lines in the first mode, and
the polarities of the data voltages are inverted every six data lines in the second mode.

13. The display apparatus of claim 6, wherein the polarity inversion driving method comprises a first mode, a second mode and a third mode,
the polarity converting part converts the polarity inversion driving method among the first mode, the second mode and the third mode according to the comparing signal,
polarities of the data voltages are inverted every data line in the first mode,
the polarities of the data voltages are inverted every two data lines in the second mode, and
the polarities of the data voltages are inverted every six data lines in the third mode.

14. The display apparatus of claim 5, wherein the timing controller comprises:
a feedback part which compares a fed-back common voltage from the display panel with a reference voltage and generates a comparing signal; and
a polarity converting part which converts a polarity inversion driving method of the display panel based on the comparing signal.

15. A method of driving a display panel, the method comprising:
generating a plurality of gate signals;
outputting the plurality of the gate signals to a plurality of gate lines;
generating a plurality of data voltages;
outputting the plurality of the data voltages to a plurality of data lines;
generating a plurality of common voltages; and
outputting the plurality of the common voltages to a plurality of driving blocks of the display panel.

16. The method of claim 15, further comprising:
comparing a fed-back common voltage from the display panel with a reference voltage;
generating a comparing signal based on a result of comparing the fed-back common voltage with the reference voltage; and
converting a polarity inversion driving method of the display panel based on the comparing signal.

17. The method of claim 16, wherein generating the comparing signal comprises:
comparing the fed-back common voltage with a first reference voltage greater than a target common voltage;
outputting a first comparing signal when the fed-back common voltage is greater than the first reference voltage;
comparing the fed-back common voltage with a second reference voltage less than the target common voltage; and
outputting a second comparing signal when the fed-back common voltage is less than the second reference voltage.

18. The method of claim 17, wherein generating the comparing signal further comprises:
comparing the fed-back common voltage with a third reference voltage greater than the first reference voltage;
outputting a third comparing signal when the fed-back common voltage is greater than the third reference voltage;
comparing the fed-back common voltage with a fourth reference voltage less than the second reference voltage; and
outputting a fourth comparing signal when the fed-back common voltage is less than the fourth reference voltage.

19. The method of claim 17, wherein converting the polarity inversion driving method of the display panel comprises determining connections between a plurality of data voltage amplifiers and the plurality of the data lines using a multiplexer disposed between the plurality of the data voltage amplifiers and the plurality of the data lines.
